(19) United States
(12) Patent Application Publication
(10) Pub. No.: US 2008/0206454 A1
(43) Pub. Date: Aug. 28, 2008

(54) Composition Of Primer Solution For Use With An Optical Article And Method Of Priming An Optical Article

(75) Inventor: Hannah Vu, New Brighton, MN (US)

Correspondence Address: INSKEEP INTELLECTUAL PROPERTY GROUP, INC, 2281 W. 190TH STREET, SUITE 200, TORRANCE, CA, 90504, US

(73) Assignee: Insight Equity A.P.X., L.P. (dba Vision-Ease Lens)

(21) Appl. No.: 11/679,761

(22) Filed: Feb. 27, 2007

(51) Int. Cl. B05D 5/06

(52) U.S. Cl. 427/162; 106/287.14

(57) ABSTRACT

A composition of silane-containing primer solution for use with an optical article, and a method of covering an optical article, that leads to improved adhesion characteristics and an extended primer solution shelf life.

### FIELD OF THE INVENTION

The present invention relates to a primer solution for use with an optical article and particularly relates to a primer solution for an ophthalmic lens.

### BACKGROUND OF THE INVENTION

The present invention relates to a composition of primer solution for use with an optical article that includes a covering layer. Primer solutions are used in the fabrication of optical articles in order to provide an intermediate layer between a base layer (such as a lens layer) and a covering layer, such as an abrasion resistant layer. The intermediate primer layer provides at least two functions. First, the primer layer acts as a physical buffer, absorbing energy, or thermal shock, and thus preventing cracks from forming in the covering layer upon being joined with the lens layer. Second, the intermediate primer layer acts as a chemical primer, providing a strong chemical intermediate for the covering layer, and thus adhering the lens layer to the covering layer. In order to better understand the context of the present invention, the three basic components of a covered optical article, namely the base layer, the covering layer, and the primer layer, will now be discussed individually.

Base Layer

The base layer of an optical article may be selected from among any materials otherwise acceptable for use in optics devices such as optical lenses and camera lenses, field glasses or other optical apparatus, such as beam splitters, prisms, mirrors, or window panes. Examples of suitable base layer materials include transparent glass and crystal, as well as a variety of plastics, including but not limited to, polycarbonates and acrylics. Organic materials such as polycarbonate resins are particularly useful as a base layer for an ophthalmic lens due to high refractive index, high impact resistance and low density. However, polycarbonate lenses are typically soft and highly susceptible to surface abrasions. As a result, such lenses typically incorporate a covering or coating, which both strengthens and protects the underlying lens. Such coverings or coatings are discussed below.

Covering Layer

Various processes of covering an optical article are known in the art. Typically, a base lens is primed and then further coated with a substance that provides abrasion-resistance and other advantageous properties in the lens, such as reflection reduction. Examples of coverings range from laminates or films, to coverings such as hard coat formulations prepared from organic and inorganic resins. Where coverings are comprised of solutions, coating methods employed to apply the covering typically include a dip or spin method, both of which are known in the art.

Resins used as hard coat coverings often include silanes, which are typically cured to a primed base lens either thermally or by irradiation. Siloxane-containing heat curable coatings, for example, may contain one or more siloxane monomers, one or more alcoholic solvents, deionized or distilled water, one or more acids, one or more of flow modifiers, and one or more of other additives such as slip additives in order to provide sufficient chemical stability, wetting, flow, and leveling of the coating and ultimately, curing and adhesion to the lens surface.

Heating temperatures for curing a hard coat will vary depending on the composition of the coating resins or materials used, heat stability of the lens materials and depending on whether single or multiple coating layers are to be applied. Typically, however, hard coat curing temperatures will be in the range of 50 to 280 or more degrees F.

Particularly in the field of ophthalmic lenses, it is well-known that providing a covering or coating to a lens is advantageous to protect or otherwise obtain certain desirable functional properties. One example of a protective covering applied to an ophthalmic lens is the use of a silane-containing polyurethane-based thermally curable coating, as described in numerous patents including U.S. Pat. Nos. 4,547,397, 5,357,024, 5,385,955 and 6,538,092, each of which are incorporated by reference herein in their entireties. Applying this type of covering provides several desirable functional properties, including strengthening of a typically thin, polycarbonate-based ophthalmic lens, as well as providing a covering that reduces abrasion to the lens surface that may otherwise arise during handling and production of the lens. Another attribute of silanated polyurethane-based curable coatings is to provide a water-repellant attribute to the lens surface. A water-repellant surface further protects the lens from becoming soiled during the production and handling of the lens. It also helps to maintain a pure and chemically uncompromised lens surface so that it can receive additional coverings, such as anti-reflective coverings or laminates.

Primer Layer

As stated previously, prior to applying a covering layer, an optical surface is typically treated with a primer layer that facilitates the application of the covering layer. Commercially available primer solutions typically comprise some of the polymers used to create heat curable covering layers, organic solvents, deionized or distilled water and other additives such as flow modifiers and leveling agents. Such exemplary primer solutions are disclosed in U.S. Pat. Nos. 4,364,885, 5,316,791 and 5,972,158, each of which are incorporated by reference herein.

Polymers used in primer solutions are typically polyurethane-containing solutions such as an aqueous dispersion of polyurethane solvent-borne polyurethane. In general, a polyurethane is typically created from raw materials such as isocyanates and polyols. Two types of commercially available isocyanates are aromatic isocyanates and aliphatic isocyanates, with aliphatic isocyanates possessing the characteristic of excellent UV stability. There are two main types of polyols used in the commercial polyurethane industry, namely polyether and polyester. Polyethers are more widely used and have a relatively low molecular weight in the range of 500-3000. The functionality of the polyether polyol is normally 2. Polyester polyols are typically produced by the condensation reaction of a diol such as ethylene glycol with a dicarboxylic acid. Polyester polyols tend to develop polyurethanes with superior tensile, abrasion, flexing and oil resistance properties than the less-expensive, less viscous polyethers. The selection of particular isocyanates and polyols suitable for the production of an aqueous polyurethane dispersion is generally the same as that known from conventional polyurethane chemistry.

Another example of polymer that may be used in the primer solution is an emulsion of an acrylic polymer or copolymer. Examples of acrylic polymers are methyl methacrylate and other acrylate-containing polymers. Acrylic copolymers are products of the emulsion polymerization of an acrylic polymer with other polymer such as, for example, polyvinyl acetate and polystyrene.

A primer solution generally possesses chemical properties that permit curing of the primer to the base lens either at ambient temperatures or via a thermal or ultraviolet curing step. Historically, the application of a primer solution onto a base lens to form a primer layer has required a heat step. U.S. Pat. No. 5,310,577, incorporated by reference in its entirety herein, is an example of a primer that requires such a heat step. It discloses a thermoset blocked isocyanate-polyurethane primer in which a heating step provides a lens environment adequate to further polymerize or chemically bond the lens base layer with a subsequently applied coating to the lens. The requirement of a heat treatment or other curing step and various additional chemical components both in primer solution and a subsequently applied covering have been required and employed to ensure sufficient adhesion of the covering layer to the base layer, without compromising the physical or chemical integrity of the lens.

However, primer solutions have also been developed that cure at ambient temperatures, thus not requiring a heat (e.g., a thermal or radiation) curing step. Curing times at ambient temperatures (typically regarded as between 70 and 80 degrees F.) vary depending on room conditions and the particular chemical composition of the primer solution. It is preferable, however, that the curing time be less than one hour and most preferably less than 15 minutes. U.S. Pat. No. 5,316,791 (“the '791 patent”), incorporated by reference in its entirety herein, purports to disclose one such primer solution. It discloses a primer solution consisting of an aqueous polyurethane dispersion not requiring a heating step for curing a primer layer to a lens surface. It is further suggested in the '791 patent that the disclosed cured aqueous polyurethane dispersion provides a lens environment that will not promote dissolving of a subsequently applied covering or create tacking of the polyurethane-containing primer layer.

Though obviating the need for a heating step, one problem not addressed by the '791 patent is adhesion of the covering layer to the base layer. Commercially available primer solutions have been shown to fail industry standard adhesion tests (such as Boiling DI water and Tinting Adhesion tests as known in the art) within 10 minutes of initiating test conditions.

Another problem exhibited by commercially available primer solutions is the short shelf lives of these solutions. The primer solution described in U.S. Pat. No. 6,858,305 uses a mixture of polyurethane and acrylic latex and another crosslinking agent as a primer. Such primer solutions have shelf lives as short as one day. With such a short duration, primer solutions require frequent disposal when not timely utilized and, thereafter, remaking of new batches of primer solutions. This process is wasteful, time-consuming and costly. Therefore, use of current commercially available primer solutions can be both expensive and inefficient, specifically in the ophthalmic lens production industry.

Hence, there exists a need for a primer solution that is curable at ambient temperatures within a reasonable time period. There is also a need for a primer solution that improves the adhesion environment of an optical article. Further, there exists a need for a primer solution with an extended shelf life.

### OBJECTS AND SUMMARY OF THE INVENTION

In view of the foregoing, it is an object of the present invention to provide a primer solution that overcomes the limitations of the prior art.

It is another object to provide a process wherein the primary step is made more efficient and economical.

These and other objects not specifically enumerated here are addressed by the present invention wherein one object of the present invention provides a composition of primer solution for use with an optical article. In particular, the present invention relates to a silane-containing primer solution. More specifically, the composition of the present invention provides a primer solution comprising an organic solution such as aqueous dispersion of polyurethane, a polyurethane solution or an emulsion of acrylic polymer or copolymer, and an amount of silane sufficient to operably promote improved adhesion of a covering layer to a base layer of an optic article, while still maintaining an extended shelf life of said primer solution.

Another object of the present invention relates to a method of priming an optical article. The method includes preparing a primer solution comprising an aqueous organic solution and an amount of silane, applying the primer solution to a base layer of an optical article in a manner to facilitate the application of a covering layer to a base layer, and then applying a covering to the base layer as primed by the primer solution.

### DETAILED DESCRIPTION OF THE INVENTION

The present invention provides a primer solution usable to prime a base layer of an optical article, such as a polycarbonate ophthalmic lens, forming a primer layer thereon. When cured, preferably at ambient temperatures, the primer layer may range in thickness from about 0.05 to about 5 microns, and is preferably from about 0.1 to about 2.0 microns in thickness. Once the primer layer is formed, a covering layer is applied and, preferably, thermally cured. One non-limiting example of a covering suitable for use in the present invention is a thermally-curable siloxane-containing hard coat. The siloxane-containing hard coat may be any commercially available hard coat, including but not limited to, hard coats used in the ophthalmic lens industry.

Prior to receiving the primer solution, the base layer may be pre-treated or otherwise cleaned. The base layer is then coated on at least one surface with the primer solution. One skilled in the art will realize several coating methods may be utilized in practicing the present invention.

For example, the base layer may be dip coated in the primer solution, preferably with an extract rate of 0.02 to 1.5 in/second to form the primer layer. The primer layer is then cured at ambient temperatures preferably for a duration of less than one hour and, most preferably, no longer than 15 minutes. Optionally, the primer layer may thereafter be pre-cured at 70 to 130 degrees F. for 10 to 60 minutes prior to application of a subsequent covering layer. A covering layer in the preferred embodiment is thereafter applied to the primed base layer and preferably cured for approximately 2 to 8 hours at 220 to 280 degrees F. If desired, an additional covering, such as an anti-reflective coating, may be applied to the thermally-cured siloxane-containing hard coat.

A preferred embodiment of the primer coating of the present invention contains an aqueous polyurethane dispersion, a polyurethane solution or an emulsion of acrylic polymer or copolymer, that is thereafter combined with at least one or more organic solvents, deionized water, flow modifier(s), and an amount of silane. Examples of organic solvents would include, for example, methanol, ethanol, isopropanol, n-propanol, n-butanol, methyl ethyl ketone or glycol ether PM. Examples of flow modifiers would include Air Product Surfonyl SF100, 3M FC430, Dow Corning DC29 and Byk Chemie Byk 333. The amount of silane in the primer solution could range from 0.01 to 5% weight percent in solution, and more preferably, 0.02 to 3% weight percent in solution.

The primer layer may include, but is not limited to, organosilanes and more specifically, silanes, which typically include at least a silicon to carbon bond. A preferred type of silane contemplated for use in the present invention includes siloxanes or alkoxy silane derivatives, which generally include silane compounds comprising at least an oxygen bridge from a silicon to an organic group.

Another preferred embodiment of the present invention includes primer solution formed by combining an aqueous polyurethane dispersion, one or more of alcoholic solvents (e.g., methanol, ethanol, isopropanol and 2-methoxy 1-propanol), a flow modifier, and an amount of silane. These components are then mixed at room conditions to form an embodiment of the primer solution of the present invention. One skilled in the art will realize that various solutions for each of the above-referenced primer solution components may be utilized while practicing the present invention.

Although it is not fully understood why the silane improves the primer in the manner it does, nor does the inventor want to be bound by the proposed theory, it is believed by the inventor that many primers fail the adhesion test in tinting solution or boiling DI water due to the poor hydroscopic properties of the polymers. Further, it is believed that the presence of silane improves the hydroscopic properties of the polymers, especially polyurethanes. After applying a silane-containing primer solution onto the lens materials and allowing the solvents to evaporate, the reaction between the polymer and silane increase the molecular weight of the polymer and, therefore, the hydroscopic properties. Silanes act as a coupling agent to improve the bonding between the lens materials and the covering layer, especially when the covering layer is a silane- or siloxane-containing hard coating. The concentration of the silane, however, is sufficiently low and the polymer content in the primer solution is also sufficiently low so that the concentration of the crosslinked polymer is below the critical gel concentration, hence maintaining the extended shelf life of the solutions.

### EXAMPLES

The composition of primer solution used and the method of priming optical articles of the present invention will now be illustrated in more detail in reference to examples, which are for illustration purposes only and should not in any way be construed as a limitation upon the scope of the invention. Each of the lenses produced in the following examples and comparative examples were tested for abrasion resistance and adhesion according with the following tests:

Abrasion Resistance Testing

The abrasion resistance is expressed as the Bayer ratio, which shows the relative abrasion resistance of the test specimen as compared to a standard lens, which is commonly manufactured and used as a benchmark in the ophthalmic lens industry. Higher Bayer ratios indicate greater degrees of abrasion resistance. The Bayer ratio is determined by making percent haze measurements of a test specimen that is to be measured and then comparing that haze measurement with similar measurements of an uncoated standard reference lens. The haze measurements of each are made both before and after the lenses are concurrently abraded in an oscillating sand abrader (ASTM F735-81). Uncoated CR-39® (poly[di(ethylene glycol) bis(allyl carbonate)]) lenses are used as the reference lenses. The abrader is oscillated for 300 cycles with 500 grams of aluminum zirconium oxide (ZF 152412 as supplied by Saint Gobain Industrial Ceramics, New Bond Street, P.O. Box 15137, Worcester, Mass. 01615-00137). The haze is measured using a hazeguard plus haze meter from BYK Gardner. The Bayer ratio is expressed as:

$$Bayer ratio = \frac{\begin{matrix}final percent haze of standard - \\ initial percent haze of standard\end{matrix}}{\begin{matrix}final percent haze of speciment - \\ initial percent haze of specimen\end{matrix}}$$

Haze is often measured by a haze meter, in which collimated light is directed against a surface, and the intensity of the light is measured (often as a percent of scattered light).

Higher Bayer ratios indicate greater degrees of abrasion resistance. Values of the Bayer ratio between 2 and 4 are a significant improvement over CR-39® lenses, which are the industry standard. Higher Bayer ratios, however, are only desirable as long as the other properties (e.g., moisture sensitivity, adhesion, coloration, and flexibility) are not adversely affected.

Adhesion Testing

Adhesion of the coating (i.e., the covering layer) to the substrate (i.e., the base layer) is tested by the crosshatch adhesion method whereby a crosshatch pattern of 100-1 mm.times.1 mm squares is scribed on the coating surface using a Cross-hatch blade. Tape (Scotch Tape 600, 3M Co.) is applied on the pattern and pulled away for 5 times. Visible peeling of the coating where the tape is applied is considered adhesion failure. Initial adhesion of the coating is tested after the coating is cured and conditioned at room conditions for a day.

For coated lenses used in the ophthalmic industry, the coating goes through a tinting process in certain circumstances. Post-tint adhesion, hence, is important. The coated and cured coating is immersed in almost boiling BPI Black dye solution (1% Transmission, BPI Co.) for 30 minutes and then rinsed with DI water. Adhesion as described above is then tested to provide post-tint adhesion values.

### Comparative Example 1

127.3 grams of aqueous polyurethane dispersion Witcobond 240® was mixed with 573 grams of a blend of solvent of 70 volume % isopropanol and 30 volume % of ethylene glycol dimethyl ether and 0.7 grams of FC430 at room temperature. All of the components were combined, stirred for 5 minutes, and then stored overnight prior to use. The next day the solution was applied to polycarbonate lenses with the dip coating method, which is widely known in the ophthalmic lens industry. The extraction speed for the lenses out of the solution was 0.07 in/s. The primer was dried at room conditions for 30 minutes before a hard coating was applied. A commercially available siloxane-based thermally curable hard coating was then applied to the primed lens at room temperature with the dip method with an extraction speed of 3 in/s, to a coating thickness of 4 microns. The coating was pre-cured in an oven at 180 degrees F. for 20 minutes to an untacky state and then further cured in an oven at 265 degrees F. for 4 hours. The test results showed that the Bayer ratio was 5.5, and showed failed adhesion after 10 minutes of tinting.

### Comparative Example 2

500 grams of commercial solvent polyurethane Sierra L1568 in diacetone alcohol was combined with 287.5 grams of isopropanol. The solution was then applied to polycarbonate lenses at a thickness of 0.4 microns and dried at room conditions for 1 hour. A commercially available siloxane-based thermally curable hard coating was then applied to the primed lens at room temperature with the dip method with an extraction speed of 3 in/second, to a coating thickness of 4 microns. The coating was then cured at 265 degrees F. for 4 hours. The test results show that the Bayer ratio was 4.8. The coating showed crack/craze after 10 minutes in a tint bath and after 30 minutes in boiling DI water. Therefore, the crack/craze effect prohibited performance of any further adhesion tests.

### Comparative Example 3

51.6 grams of commercial aqueous dispersion polyurethane Hauthaway L2393 with 35% solid was combined with 544.8 grams of deionized water and 3.6 grams of 5% Byk 333 in ethanol. The solution was then applied to polycarbonate lenses at a thickness of 0.35 microns and dried at room conditions for 1 hour. A commercially available siloxane-based thermally curable hard coating was then applied to the primed lens at room temperature with the dip method with an extraction speed of 3 in/second, to a coating thickness of 4 microns. The coating was then cured at 265 degrees F. for 4 hours. The coating failed adhesion after 30 minutes in boiling DI water and the coating became very hazy.

### Comparative Example 4

44 grams of commercial aqueous dispersion polyurethane Incorez W2600 was combined with 552.4 grams of deionized water and 3.6 grams of 5% Byk 33 in ethanol. The solution was then applied to polycarbonate lenses at a thickness of 0.35 microns and dried at room conditions for 1 hour. A commercially available siloxane-based thermally curable hard coating was then applied to the primed lens at room temperature with the dip method with an extraction speed of 3 in/second, to a coating thickness of 4 microns. The coating was then cured at 265 degrees F. for 5 hours. The test results show that the Bayer ratio was 3.9. The coating failed adhesion after 10 minutes in BPI Black tinting bath at 210 degrees F. The coating also failed adhesion after 30 minutes in boiling DI water and the coating cracked.

### Example 1

The composition of primer solution of the present invention was prepared as follows: 122 grams of diluted aqueous polyurethane dispersion with a low solid of less than 10% Witcobond 240® was mixed with 552 grams of a blend of solvent of 70 volume % Glycol ether PM and 30 volume % of Isopropanol, 7 grams of FC340 10% in Glycol ether PM, and 2.4 grams 3-glycidoxy propyl trimethoxy silane at room temperature. All of the components were mixed and stirred for 5 minutes and left overnight before use.

The primer solution was then applied to a polycarbonate lens at room temperature with the dip method, with an extraction speed of 2.5 in/s. The resulting primer layer thickness was measured at 0.78 microns. A commercially available siloxane-based thermally curable hard coating as in example 1 was then applied to the primed lens at room temperature with the dip method with an extraction speed of 3 in/s, to a coating thickness of 4.48 microns. The hard coating was then pre-cured in an oven at 165 degrees F. for 20 minutes to an untacky state and then further cured at 265 degrees F. for 4 hours. The resulting covered lens passed a thermal shock test, which test is widely known in the ophthalmic lens industry. The test results showed that the Bayer ratio was 7.74±0.44, and that the coated lenses passed 30 minutes, thus indicating improved adhesion, in both the tinting adhesion test and the boiling DI water test. Further, the initial haze was measure at 0.14% and the total light transmittance was 90.8%. The solution was stored at room conditions and still stable after 1 year.

### Example 2

51.6 grams of commercial aqueous dispersion polyurethane Hauthaway L2393 with 35% solid was combined with 544.8 grams of isopropanol and 3.6 grams of 5% Byk 333 in ethanol. The solution was then applied to polycarbonate lenses at a thickness of 0.35 microns and dried at room conditions for 1 hour. A commercially available siloxane-based thermally curable hard coating was then applied to the primed lens at room temperature with the dip method with an extraction speed of 3 in/second, to a coating thickness of 4 microns. The coating was then cured at 265 degrees F. for 4 hours. The coating passed adhesion after 30 minutes in boiling DI water and 30 minutes in BPI black tinting bath at 212 degrees F.

### Example 3

The composition of primer solution of the present invention was shown to possess reduced particulates in the final prepared primer solution when prepared in the following manner: 573 grams of a blend of solvent of 70 volume % isopropanol and 30 volume % of ethylene glycol dimethyl ether were combined and continually stirred. 127.3 grams of diluted aqueous polyurethane dispersion with 30% solid Witcobond 240® was mixed into the above continually stirring mixture. A small percentage of siloxane, specifically 0.3% in final solution, was combined slowly with the above-described stirring solution. 0.7 grams of FC430 was combined into the above-described stirring solution. The entire solution was thereafter stirred for an additional 30 minutes at room conditions and stored overnight for later use. The inventor visually observed a noticeable reduction in particles in final solution, through combining the components in the manner described herein.

It has also been discovered that the composition and method of making of the primer solution leads to a shelf life that is longer than known primer solutions of the prior art. For example, the primer solution used in Comparative Example 3 is known to the inventor to require use within 24 hours of the creation of the solution whereas the primer solution of the present invention remains suitable for use as long as 1 year following the creation of the solution.

In closing, it is to be understood that the exemplary embodiments disclosed herein are illustrative of the principles of the invention. Other modifications that may be employed are within the scope of the invention. Thus, by way of example, but not of limitation, alternative configurations may be utilized in accordance with the teachings herein. Accordingly, the description is illustrative and not intended to be a limitation thereof.

What is claimed is:

1. A primer solution for use with an optic article comprising silane.

2. A composition of primer solution for use with an optic article, comprising:
an organic solution; and
an amount of silane.

3. The composition of primer solution of claim 2, wherein said organic solution comprises a polyurethane solution.

4. The composition of primer solution of claim 2, wherein said organic solution comprises an aqueous dispersion of polyurethane.

5. The composition of primer solution of claim 2, wherein said organic solution comprises an emulsion of acrylic polymer or copolymer.

6. The composition of primer solution of claim 2, wherein the amount of siloxane ranges between 0.01 and 5 weight percent in solution.

7. The composition of primer solution of claim 2, wherein the amount of siloxane ranges between 0.02 and 3 weight percent in solution.

8. The composition of primer solution of claim 2, wherein the aqueous organic solution comprises at least one organic solvent.

9. A composition of primer solution for use with an optic article, comprising an organic solution comprising polyurethane, at least one organic solvent, at least one alcohol, a flow modifier, and an amount of silane.

10. A method of prolonging the shelf life of an optical article primer solution comprising:
adding a predetermined quantity of silane to the primer solution during preparation of the primer solution.

11. The method of claim 10, wherein adding a predetermined quantity of silane to the primer solution during preparation of the primer solution comprises adding between 0.01 and 5 weight percent in solution of silane.

12. The method of claim 10, wherein adding a predetermined quantity of silane to the primer solution during preparation of the primer solution comprises adding between 0.02 and 3 weight percent in solution of silane.

13. A method of improving adhesion characteristics as between a base layer of an optical article and a subsequently-applied covering layer comprising:
adding a predetermined quantity of silane to a primer solution;
applying said primer solution to the base layer of the optical article and thereafter, curing said primer solution to form a primer layer on the base layer; and
applying at least one covering to said primer layer.

14. The method of claim 13, wherein curing said primer solution comprises curing said primer solution at ambient temperatures.

15. The method of claim 13, wherein curing said primer solution comprises curing said primer at elevated temperature below 200 degree Fahrenheit.

16. The method of claim 13, wherein adding said predetermined quantity of silane to said primer solution comprises adding between 0.01 and 5 weight percent silane to said primer solution.

17. The method of claim 13, wherein applying said primer solution to said base layer comprises applying said primer solution to a polycarbonate lens.

18. The method of claim 13, wherein applying at least one covering layer to said base layer comprises applying a hard coat to said base layer.

19. The method of claim 13, wherein applying at least one covering layer to said base layer comprises applying an anti-reflective coating to said base layer.

20. A method of preparing an optical article for receiving a covering, comprising:
preparing a primer solution including an aqueous organic solution and an amount of silane;
applying said primer solution to said optical article prior to said optical article receiving said covering, so as to prime said optic article to receive said covering;
curing said primer solution on said optical article.

21. The method of claim 20, wherein preparing a primer solution including an aqueous organic solution and said amount of silane comprises preparing an aqueous polyurethane dispersion solution and an amount of silane.

22. The method of claim 20, wherein preparing a primer solution comprising an aqueous organic solution and said amount of silane comprises preparing an aqueous polyurethane dispersion solution and an amount of hydrolyzed epoxy propyl trimethoxy silane.

23. The method of claim 20, wherein curing said primer solution on said optical article comprises curing said primer solution on said optical article at ambient temperatures.

24. The method of claim 20, wherein preparing said primer solution including an aqueous organic solution and an amount of silane comprises preparing said primer solution including an aqueous organic solution and an amount of silane ranging between 0.01 and 5 weight percent in solution.

25. The method of claim 20, wherein said preparing said primer solution including an aqueous organic solution and an amount of silane comprises preparing said primer solution including an aqueous organic solution and an amount of silane ranging between 0.02 and 3 weight percent in solution.

26. A method of preparing a surface for receiving a covering, comprising:
applying a silane-containing organic solution to a surface prior to placing a covering on said surface.

27. The method of claim 26, wherein applying a silane-containing organic solution to said surface comprises applying a solution comprising silane and a polymer to said surface.

28. The method of claim 26, wherein applying a solution comprising silane and a solvent to said surface comprises applying a solution including an amount of silane and a solvent including an aqueous polyurethane dispersion to said surface.

29. The method of claim 26, wherein preparing a surface for receiving a covering comprises preparing an optical surface for receiving a coating.

30. The method of claim 26, wherein preparing a surface for receiving a covering comprises preparing a lens surface for receiving a coating.

31. The method of claim 26, wherein preparing a surface for receiving a covering comprises preparing a polycarbonate surface for receiving a coating.

32. The method of claim 26, wherein preparing a surface for receiving a covering comprises preparing an optical surface for receiving a laminate.
